(19) United States
(12) Patent Application Publication
(10) Pub. No.: US 2023/0014696 A1
(43) Pub. Date: Jan. 19, 2023

(54) RECIPROCATING HERMETIC COMPRESSOR WITH AXIAL FLUX MOTOR

(71) Applicant: NIDEC GLOBAL APPLIANCE BRASIL LTDA., JOINVILLE - SC (BR)

(72) Inventors: Adilson Luiz MANKE, Joinville - SC (BR); Aleandro Amauri ESPÍNDOLA, Joinville - SC (BR); Rodrigo KREMER, Blumenau - SC (BR); Alberto Bruno FELDMANN, Joinville - SC (BR); Tiago STAUDT, Joinville - SC (BR); Rinaldo PUFF, Joinville - SC (BR)

(21) Appl. No.: 17/784,527

(22) PCT Filed: Dec. 11, 2020
(86) PCT No.: PCT/BR2020/050540

§ 371 Date: Jun. 10, 2022

(30) Foreign Application Priority Data
Dec. 11, 2019 (BR) 102019026307.5
Dec. 11, 2019 (BR) 102019026308.3
Dec. 11, 2019 (BR) 102019026310.5
Dec. 11, 2019 (BR) 102019026312.1
Dec. 11, 2019 (BR) 102019026313.0

(51) Int. Cl. F04B 35/04; F04B 39/02; F04B 39/12; F04B 39/00

(52) U.S. Cl. CPC F04B 35/04; F04B 39/0261; F04B 39/128; F04B 39/0022

(57) ABSTRACT

The present invention describes a reciprocating compressor, comprising:
an assembly block (10);
a rotating shaft (20) comprising at least one inner axial channel (21), said inner axial channel (21) connected to at least one inner radial channel (22a, 22b) or to a cam (23);
the cam (23) is associated with a connecting rod (24), and the connecting rod (24) is associated with a movable piston (25) within a compression cylinder (26); and
an oil pump (C),
comprising:
an axial flow electric motor comprising a rotor (30), with magnets (31), and a stator (40) with coils (41);
wherein the rotor (30) and the stator (40) are fixed to the shaft (20) and to the assembly block (10), respectively, by means of bearings or fixing arrangements.

### TECHNICAL FIELD

The present invention relates to hermetic reciprocating compressors, preferably used in refrigeration systems, adapted to comprise, as a driving source, an axial flow electric motor.

More specifically, the present invention refers to the arrangement of the bearings necessary for the implementation of an axial flow electric motor in a hermetic reciprocating compressor and the arrangement of the rotor, in relation to the block and stator. The present invention also relates to the electric motor support arrangement for reciprocating compressor, said arrangement supports an axial flow electric motor within the hermetic housing of a compressor. In addition, the present invention also relates to the mounting of the extender element (which integrates the lubricating oil pump) between the lower end of the rotating shaft and the rotor of said axial flow electric motor.

### BACKGROUND OF THE INVENTION

The current state of the art comprises a wide range of reciprocating compressor constructions, which are widely used in refrigeration fluid compressors. In general, a reciprocating compressor has the main objective of achieving alternating suction and discharge cycles of any working fluid, and in the case of refrigeration fluid compressors, the reciprocating compressor cooperates with valves that, acting in sync with the alternating suction and discharge cycles of said reciprocating compressor, allow the discharge fluid to reach a pressure higher than the pressure of the suction fluid.

The functional principle of refrigeration compressors based on reciprocating compressors is widely known in the state of the art.

As a rule, the driving force element capable of moving the movable piston comprises an electric motor with radial flow, which is schematically illustrated in FIG. 1 of the state of the art.

In this sense, an electric motor with radial flow is fundamentally integrated by a rotor and a stator, which are built in order to establish electromagnetic interaction. Topologies in which the rotor is circularly surrounded by the stator and topologies in which the stator is circularly surrounded by the rotor are known, and in both, the rotating magnetic field between the rotor and the stator (see illustrative arrows in FIG. 1) is generated between the physical radial spacing (clearance) between said rotor and said stator.

Naturally, an electric motor with radial flow can be easily associated with a reciprocating compressor.

On the other hand, recent technological advances in the area of motors have been able to optimize electric motors with axial flow, so that they have become more energy efficient than those with radial flow. A basic construction of an axial flow electric motor can be seen in FIG. 2 of the state of the art.

In general, an axial flow electric motor is fundamentally integrated by a rotor and a stator, which are built in order to establish electromagnetic interaction. Topologies are known in which the rotor is disposed above the stator and topologies in which the stator is disposed above the rotor, and in both, the rotating magnetic field between the rotor and the stator (see illustrative arrows in FIG. 2) is generated between the axial physical spacing (clearance) between said rotor and said stator.

A problem of the state of the art is the fact that because they comprise topologies essentially different from the radial flow electric motor topologies, the axial flow electric motors are not used in reciprocating compressors, after all, numerous technical adaptations would be necessary in a reciprocating compressor so that it comes to comprise, as a driving force element, an axial flow electric motor.

Another problem of the state of the art is the fact that, unlike what occurs in radial flow electric motors, in which the electromagnetic integration between stator and rotor generates rotating (torque) and radial magnetic forces in the rotor, axial flow electric motors are also subject, in addition to the rotating magnetic force (torque) on the rotor, to a magnetic attraction force, in axial direction, between the rotor and the stator. This means that a rotating shaft linked to the rotor of an axial flow electric motor also tends to undergo, in addition to the rotary movement, an axial displacement. Accordingly, because it comprises this other vector of displacement force between rotor and stator, axial flow electric motors are not applied in reciprocating compressors, after all, the traditional embodiments of reciprocating compressors do not include mechanical elements capable of forming the mounting axial clearances of the shaft and rotor subset in the block and stator subset and handle the axial movement of the rotary shaft under transport and compressor operation conditions.

### SUMMARY

An objective of the present invention is to provide reciprocating compressor with axial flow motor.

This objective is achieved by means of a reciprocating compressor, comprising:

an assembly block;

a rotating shaft comprising at least one inner axial channel, said inner axial channel connected to at least one inner radial channel or to a cam;

the cam is associated with a connecting rod, and the connecting rod is associated with a movable piston within a compression cylinder; and

an oil pump,

comprising:

an axial flow electric motor comprising a rotor, with magnets, and a stator with coils;

wherein the rotor and the stator are fixed to the shaft and to the assembly block, respectively, by means of bearings or fixing arrangements.

One of the advantages of the present invention is the fact that it provides a reciprocating compressor comprising an axial flow motor.

Conveniently, the reciprocating compressor according to the present invention consists of the fact that the stator is located between the assembly block and the rotor.

The reciprocating compressor according to the present invention also consists of the fact that the rotor is located between the assembly block and the stator.

In addition, the reciprocating compressor according to the present invention consists of the fact that the rotor is fixed to the rotating shaft by means of a first fixing arrangement.

Additionally, the reciprocating compressor according to the present invention consists of the fact that the stator is fixed to the assembly block by means of a second fixing arrangement.

The reciprocating compressor according to the present invention further comprises an axial bearing disposed between the lower region of the upper flange of the rotating shaft and the upper region of the assembly block.

In addition, the reciprocating compressor according to the present invention further comprises an axial bearing disposed between the rotor and the stator.

In addition, the reciprocating compressor according to the present invention consists of the fact that the stator further comprises a radial bearing arranged around the rotating shaft, wherein the radial bearing is defined by an annular structure which, projected from the stator, is arranged around a segment of the rotating shaft.

The reciprocating compressor according to the present invention further comprises a third vertical projection.

Additionally, the reciprocating compressor according to the present invention comprises an axial bearing disposed between the rotor and the third vertical projection.

The present invention also provides a reciprocating compressor, comprising:

an assembly block comprising an assembly block upper part and an assembly block lower part;

the assembly block further comprising a first through hole and a second through hole;

a rotating shaft with a rotating shaft first part located in the first through hole and with a rotating shaft second part located in the second through hole;

the rotating shaft comprising an eccentric pin disposed between the first part and the second part,

the eccentric pin being associated with a connecting rod, and the connecting rod being associated with a movable piston inside a compression cylinder; and

an oil pump,

comprising:

an axial flow electric motor comprising a rotor with magnets and a stator with electric coils;

wherein the rotor and the stator are fixed to the rotating shaft and to the assembly block, respectively, by means of bearings or fixing arrangements.

Conveniently, the reciprocating compressor according to the present invention consists of the fact that the rotor is fixed to the rotating shaft by means of a first fixing arrangement.

The reciprocating compressor according to the present invention also consists of the fact that the stator is fixed to the assembly block by means of a second fixing arrangement.

In addition, the reciprocating compressor according to the present invention further comprises a first hydrodynamic radial bearing formed in the space between the inner face of the first through hole and the rotating shaft first part.

Additionally, the reciprocating compressor according to the present invention further comprises a second hydrodynamic radial bearing formed in the space between the inner face of the second through hole and the rotating shaft second part.

Reciprocating compressor, according to the present invention in which the stator further comprises an axial bearing disposed around the rotating shaft, wherein the axial bearing is defined by an annular structure which, protruding from the stator, is disposed around of a rotating shaft segment.

The reciprocating compressor according to the present invention further comprises an axial bearing disposed between the eccentric pin and the assembly block upper part.

Additionally, the reciprocating compressor according to the present invention further comprises an axial bearing disposed between the bearing hub and the rotor.

In addition, the reciprocating compressor according to the present invention also consists of the fact that the rotor is above the stator, and the rotor comprises a support structure in “Z” format for fixing to the rotating shaft.

In addition, the reciprocating compressor according to the present invention consists of the rotor and stator are separated by a first axial clearance, and the rotor and assembly block are separated by a second axial clearance.

Additionally, the reciprocating compressor according to the present invention consists of the first clearance is adjustable by using a bushing arranged between the stator and the mounting block or between the rotor and the rotating shaft.

Further, the reciprocating compressor according to the present invention consists of the fact that the second clearance is preferably adjustable by means of a bushing arranged between the rotor and the rotating shaft.

The reciprocating compressor according to the present invention also consists of the fact that the first clearance is formed by the displacement of the rotor or stator and the second clearance is generated through the displacement of a bushing or fixing arrangement.

Additionally, the reciprocating compressor according to the present invention further comprises an oil pump provided in the inner axial channel of the rotating shaft; or provided in the rotor.

In addition, the reciprocating compressor according to the present invention further comprises a fastening means that physically links the oil pump, the rotor and the rotating shaft.

An additional advantage of the method according to the present invention is to provide a simple and practical reciprocating compressor, of significantly reduced dimensions in relation to a radial engine reciprocating compressor, with adjustments of its axial clearances independently, allowing an easy industrial production and generating a robust configuration for transport and operation operations.

### BRIEF DESCRIPTION OF DRAWINGS

The objectives and advantages of the present invention will become clearer through the following detailed description of the examples and non-limiting drawings presented at the end of this document:

FIG. 1 illustrates a simplified view of the state of the art of a radial flow motor.

FIG. 2 illustrates a simplified view of the state of the art of an axial flow motor.

FIG. 3 illustrates an internal side view according to a first embodiment of the reciprocating compressor with axial flow motor according to the present invention.

FIG. 4 illustrates another internal side view according to a first embodiment of the reciprocating compressor with axial flow motor according to the present invention.

FIG. 5 illustrates another internal side view according to a first embodiment of the reciprocating compressor with axial flow motor according to the present invention.

FIG. 6 illustrates an internal side view according to a second embodiment of the reciprocating compressor with axial flow motor according to the present invention.

FIG. 7 illustrates another possible configuration of the second embodiment of the reciprocating compressor with axial flow motor according to the present invention.

FIG. 8 illustrates a possible change in the reciprocating compressor with axial flow motor according to the present invention.

FIG. 9 illustrates another possible change in the reciprocating compressor with axial flow motor according to the present invention.

FIG. 10 illustrates a further change in the reciprocating compressor with axial flow motor according to the present invention.

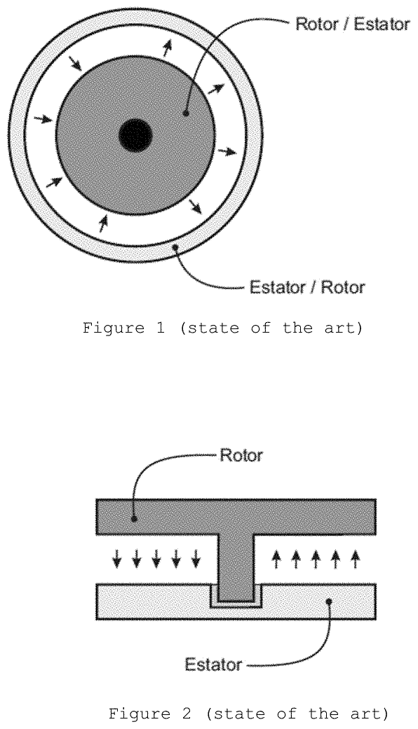

### DETAILED DESCRIPTION

### First Embodiment

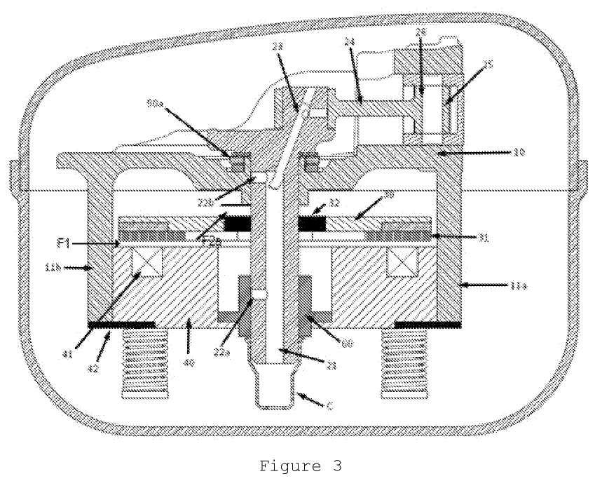

FIG. 3 illustrates a first embodiment of the reciprocating compressor with axial flow motor according to the present invention.

According to FIG. 3, the reciprocating compressor comprises an assembly block 10, a rotating shaft 20, an oil pump C and an electric motor with axial flow basically composed of a rotor 30 and a stator 40.

The assembly block 10 comprises at least a first vertical projection 11a and at least a second vertical projection 11b for fixing the stator 40. Additionally, the assembly block 10 comprises a through hole for receiving the rotating shaft 20.

Said rotating shaft 20 comprises at least one inner axial channel 21 for circulating lubricating oil, said inner axial channel 21 extending from the lower end to the upper end of said rotating shaft 20. Furthermore, the inner axial channel 21 is connected to at least one inner radial channel 22a, 22b for lubricating oil outlet, the inner axial channel 21 and the at least one inner radial channel 22a, 22b are fluidly connected to each other, so that the lubricating oil which enters the inner axial channel 21 exits through the inner radial channels 22a, 22b. In addition, the upper end of the rotating shaft 20 comprises a cam 23 associated with a connecting rod 24, the connecting rod 24 also being associated with a movable piston 25 within a compression cylinder 26.

The rotor 30 comprises magnets 31 and is fixed to the rotating shaft 20 by means of a first fixing arrangement 32, said first fixing arrangement 32 may comprise any known fixation arrangement (by interference, welding, adhesive, screw, among others). The fixing arrangement 32 having the function of transmitting the movement of the rotor 30 to the rotating shaft 20.

The stator 40 comprises electrical coils 41 and is fixed to the assembly block 10 by means of a second fixing arrangement 42, said second fixing arrangement 42 comprising any known fixing arrangement (by interference, welding, adhesive, screw, among others). The fixing arrangement 42 having the function of keeping the positioning of the stator 40, in relation to the assembly block 10, static.

Also according to FIG. 3, the rotor 30 is disposed above the stator 40. In this condition, an axial bearing 50a is provided, used to limit the relative axial displacement between rotor 30 and stator 40 and, disposed between the lower region of the upper flange of the rotating shaft 20 and the upper region of the assembly block 10. This axial bearing 50a (which may comprise, for example, a plain sliding bearing, bearing or bushings of materials with a low friction coefficient), in addition to assisting the rotation of the rotating shaft 20, also prevents said rotating shaft 20 from undergoing axial displacements due to the magnetic attraction existing between the rotor 30 and the stator 40 when the motor is started.

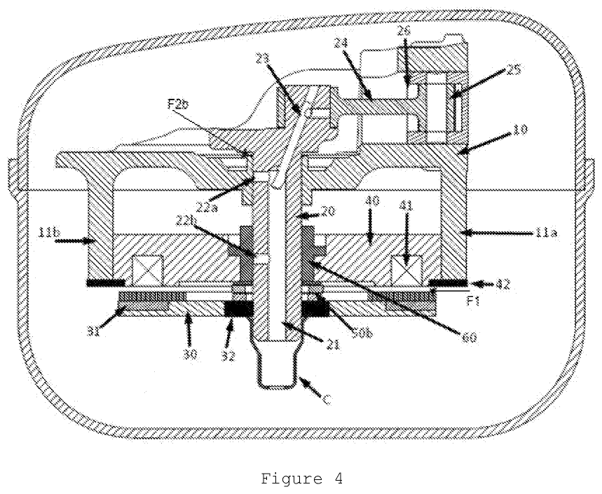

According to FIG. 4, the stator 40 is above the rotor 30. In this condition, an axial bearing 50b is provided, used to limit the relative axial displacement between rotor 30 and stator 40, and disposed between the rotor 30 and the stator 40 or between the rotor 30 and the annular structure 60.

Additionally, the first embodiment of the present invention also provides a radial bearing which, integrated with the stator 40, is arranged around the rotating shaft 20. Said radial bearing can comprise any type of bearing already known, such as, for example, a hydrodynamic bearing (bearing with some type of lubricant supply between the minimum clearance of parallel surfaces and, in this case, axially aligned) or a hydrostatic bearing (bearing with forced supply of some type of lubricant injected under pressure between two parallel surfaces and, in this case, axially aligned), or bushings of some low-friction or self-lubricating material.

According to the present invention, the general structure of the stator 40 is used to enable the formation of a radial bearing for said rotating shaft 20, so that the rotating shaft 20 does not present problems of eccentricity and misalignment.

As shown in FIGS. 3 and 4, the radial bearing is defined by an annular structure 60 integrated with the stator 40 and arranged around the rotating shaft 20. More particularly, the annular structure 60 is arranged around a segment of the rotating shaft 20 where the inner radial channel 22a is located.

Thus, the space formed between the annular structure 60 and the rotating axis 20 segment is adapted to retain a film of lubricating oil (from the inner radial channel 22a), forming a radial hydrodynamic bearing.

Thus, by taking advantage of the stator 40 structure itself to form a hydrodynamic radial bearing for the rotating shaft 20, it is possible to build a simpler and more compact assembly block 10.

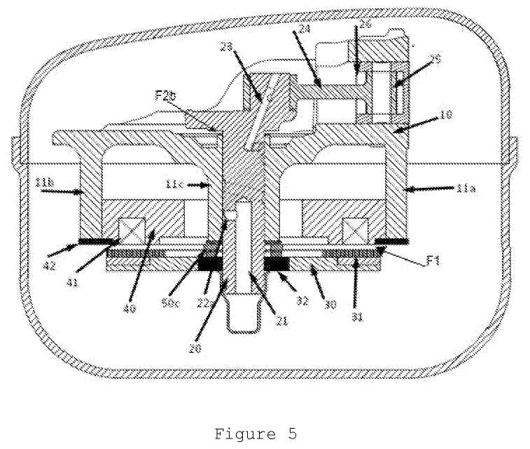

Optionally, according to FIG. 5, the assembly block 10 can comprise a third vertical projection 11c. In this configuration, the stator 40 is arranged above the rotor 30. Additionally, an axial bearing 50c is provided between the rotor 30 and the third vertical projection 11c.

### Second Embodiment

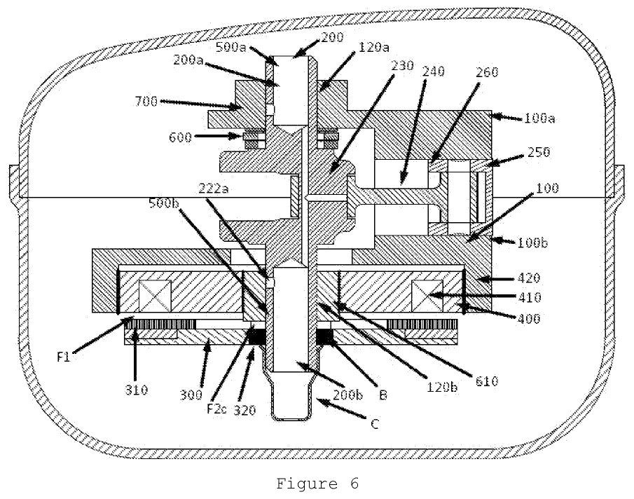

FIG. 6 illustrates a second embodiment of the reciprocating compressor with axial flow motor according to the present invention.

According to FIG. 6, the reciprocating compressor comprises an assembly block 100, with an assembly block upper part 100a and an assembly block lower part 100b, a rotating shaft 200, with a rotating shaft first part 200a and a rotating shaft second part 200b, an oil pump C and an axial flow electric motor basically composed of a rotor 300 and a stator 400.

The assembly block 100 comprises a first through hole 120a and a second through hole 120b for receiving the rotating shaft first part 200a and the rotating shaft second part 200b respectively.

The rotating shaft 200 comprises an eccentric pin 230 disposed between the first part 200a and the second part 200b, the eccentric pin 230 being associated with a connecting rod 240, the connecting rod 240 also being associated with a movable piston 250 inside of a compression cylinder 260.

The rotor 300 comprises magnets 310 and is fixed to the rotating shaft 200 by means of a first fixing arrangement 320, said first fixing arrangement 320 can comprise any known fixation arrangement (welding, adhesive, screw, among others). The fixing arrangement 320 having the function of transmitting the movement of the rotor 300 to the rotating shaft 200.

The stator 400 comprises electrical coils 410 and is fixed to the assembly block 100 by means of a second fixation arrangement 420, said fixation arrangement 420 comprising any known fixation arrangement (welding, adhesive, screw, among others). The fixing arrangement 420 having as function to keep the positioning of the stator 400, in relation to the assembly block 100, static.

As can be seen in FIG. 6, the space between the inner face of the first through hole 120a and the rotating shaft first part 200a receives a film of lubricating oil, forming a first hydrodynamic radial bearing 500a. Similarly, the space between the inner face of the second through hole 120b and the rotating shaft second part 200b also receives a film of lubricating oil, forming a second hydrodynamic radial bearing 500b. These bearings prevent premature wear of the rotating shaft 200 and of the first and second through holes 120a and 120b.

According to FIG. 6, the second embodiment of the present invention provides an axial bearing 600 to keep the axial spacing between rotor 300 and stator 400 stable. Therefore, the axial bearing 600 can be mounted between the eccentric pin 230 and the assembly block upper part 100a.

Optionally, the axial bearing 600 could also be mounted between the bearing hub 700 and the rotor 300.

Additionally, the second embodiment of the present invention also provides a radial bearing which, integrated with the stator 400, is arranged around the rotating shaft 200. Said radial bearing can comprise any type of bearing already known, such as, for example, a hydrodynamic bearing (bearing with some type of lubricant supply between the minimum clearance of parallel surfaces and, in this case, axially aligned) or a hydrostatic bearing (bearing with forced supply of some type of lubricant injected under pressure between two parallel surfaces and, in this case, axially aligned), or bushings of some low-friction or self-lubricating material.

According to the present invention, the general structure of the stator 400 is used to enable the formation of a radial bearing for said rotating shaft 200, so that the rotating shaft 200 does not present problems of eccentricity and misalignment.

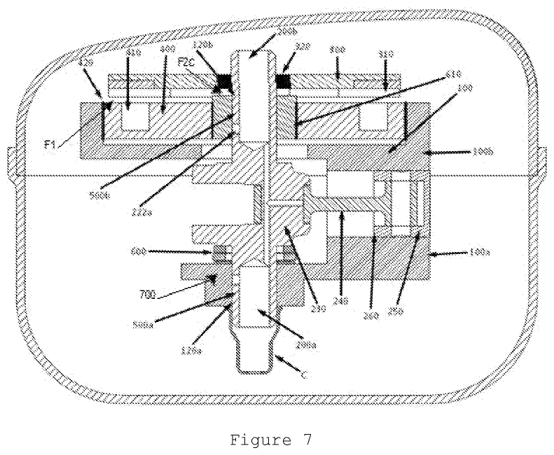

As shown in FIGS. 6 and 7, the radial bearing is defined by an annular structure 610 integrated with the stator 400 and arranged around the rotating shaft 200. More particularly, the annular structure 610 is arranged around a segment of the rotating shaft 200 where the inner radial channel 222a is located.

Thus, the space formed between the annular structure 610 and the rotating shaft 200 segment is adapted to retain a film of lubricating oil (from the inner radial channel 222a), forming a radial hydrodynamic bearing.

FIG. 7 illustrates an optional configuration of the second embodiment. In this configuration, the motor is above the cylinder.

[Configurations Applicable to the First Embodiment and to the Second Embodiment]

The present invention also provides configurations applicable to the first embodiment and to the second embodiment.

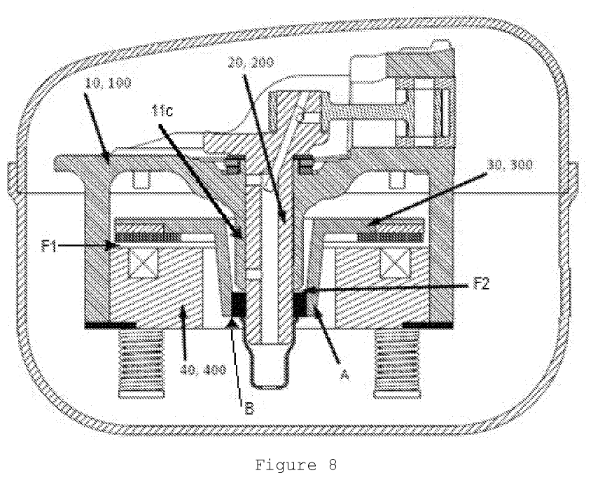

According to FIG. 8, in a configuration in which the rotor 30, 300 is above the stator 40, 400, the rotor 30, 300 comprises a support structure A in the form of “Z” for fixation to the rotating shaft 20, 200.

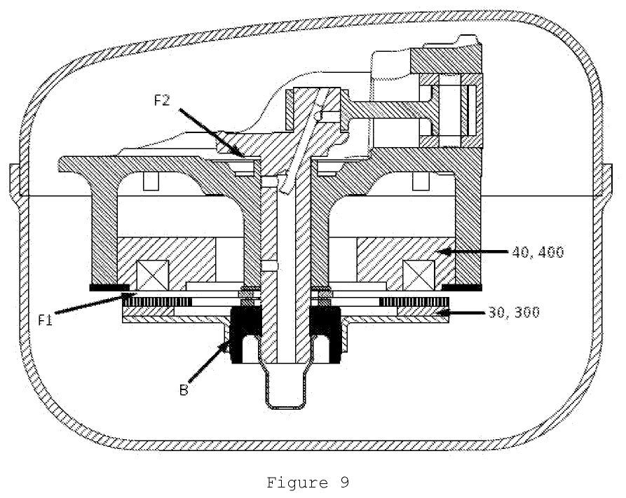

According to FIG. 9, the rotor 30, 300 and stator 40, 400 can be separated by a second axial clearance F2, and the rotary axis 30, 300 and the mounting block 10, 100 can be separated by a first axial clearance F1. The first F1 and the second F2 clearances are adjustable using a bushing B arranged between the rotor 30, 300 and the rotary axis 20, 200. Additionally, the second clearance F2 is formed by the displacement of rotor 30, 300 over the bushing B or by the displacement of stator 40, 400 over the assembly block 10, 100, while the first clearance F1 is formed by displacing the bushing B over the rotating axis 20, 200.

The bushing B is an annular (sliding) part disposed between rotor 30, 300 and shaft 20, 200, allowing the first clearance F1 to be formed regardless of the formation of the second clearance F2.

The clearance F1 defines a displacement field (for example, from 0.1 to 0.5 mm) for the axis, preventing it from getting stuck (if F1=0) or with very high displacement, generating problems mainly during transport. Once the clearance F1 is formed, the clearance F2 (between rotor and stator) can be adjusted without changing F1.

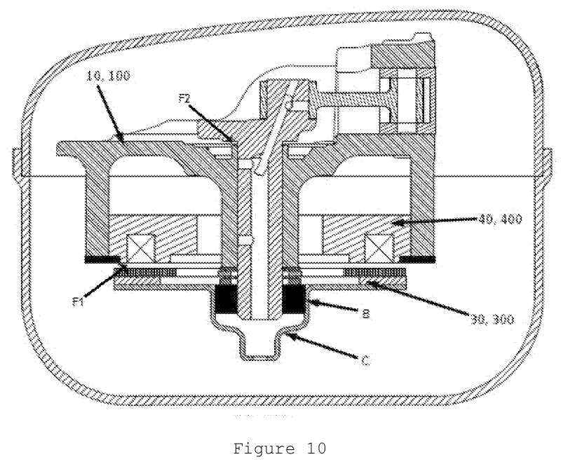

According to FIG. 10, an oil pump Cl of frustum-conical shape can be provided in the inner axial channel 21 of the rotating shaft 20, 200 or can be provided in the rotor 30, 300. Thus, the oil intake is optimized. Additionally, the oil pump Cl also acts as an interface of physical contact between the rotor 30, 300 and the rotating shaft 20, 200, ensuring the fixation of these elements and transmitting the movement of the rotor 30, 300 to the rotating shaft 20, 200. The oil pump Cl can be fitted under interference on the rotating shaft 20, 200.

In addition to the embodiments presented above, the same inventive concept can be applied to other alternatives or possibilities of using the invention, such as, for example, in air compressors.

Although the present invention has been described in relation to certain preferred embodiments, it should be understood that it is not intended to limit the invention to those particular embodiments. On the contrary, it is intended to cover all possible alternatives, modifications and equivalences within the spirit and scope of the invention, as defined by the attached claims.

1. Reciprocating compressor, comprising:
an assembly block (10);
a rotating shaft (20) comprising at least one inner axial channel (21), said inner axial channel (21) connected to at least one inner radial channel (22a, 22b) or to a cam (23);
the cam (23) is associated with a connecting rod (24), and the connecting rod (24) is associated with a movable piston (25) within a compression cylinder (26); and
an oil pump (C),
characterized in that it comprises:
an axial flow electric motor comprising a rotor (30), with magnets (31), and a stator (40) with coils (41);
wherein the rotor (30) and the stator (40) are fixed to the shaft (20) and to the assembly block (10), respectively, by means of bearings or fixing arrangements.

2. Reciprocating compressor, according to claim 1, characterized in that the stator (40) is located between the assembly block (10) and the rotor (30).

3. Reciprocating compressor, according to claim 1, characterized in that the rotor (30) is located between the assembly block (10) and the stator (40).

4. Reciprocating compressor, according to claim 1, characterized in that the rotor (30) is fixed to the rotating shaft (20) by means of a first fixing arrangement (32).

5. Reciprocating compressor, according to claim 1, characterized in that the stator (40) is fixed to the assembly block (10) by means of a second fixing arrangement (42).

6. Reciprocating compressor, according to claim 1, characterized in that it further comprises an axial bearing (50a) disposed between the lower region of the upper flange of the rotary shaft (20) and the upper region of the assembly block (10).

7. Reciprocating compressor, according to claim 1, characterized in that it further comprises an axial bearing (50b) disposed between the rotor (30) and the stator (40).

8. Reciprocating compressor, according to claim 1, characterized in that the stator (40) further comprises a radial bearing arranged around the rotating shaft (20), wherein the radial bearing is defined by an annular structure (60) which, projected from the stator (40), is arranged around a segment of the rotating shaft (20).

9. Reciprocating compressor, according to claim 1, characterized in that it further comprises a third vertical projection (11c).

10. Reciprocating compressor, according to claim 1, characterized in that it further comprises an axial bearing (50c) disposed between the rotor (30) and the third vertical projection (11c).

11. Reciprocating compressor, comprising:
an assembly block (100) comprising an assembly block upper part (100a) and an assembly block lower part (100b);
the assembly block further comprising a first through hole (120a) and a second through hole (120b);
a rotating shaft (200) with a rotating shaft first part (200a) located in the first through hole (120a) and with a rotating shaft second part (200b) located in the second through hole (120b);
the rotating shaft comprising an eccentric pin (230) disposed between the first part (200a) and the second part (200b),
the eccentric pin (230) being associated with a connecting rod (240), and the connecting rod (240) being associated with a movable piston (250) inside a compression cylinder (260); and
an oil pump (C),
characterized in that it comprises:
an axial flow electric motor comprising a rotor (300) with magnets (310) and a stator (400) with electric coils (410);
wherein the rotor (300) and the stator (400) are fixed to the rotating shaft (200) and to the assembly block (100), respectively, by means of bearings or fixing arrangements.

12. Reciprocating compressor, according to claim 11, characterized in that the rotor (300) is fixed to the rotating shaft (200) by means of a first fixing arrangement (320).

13. Reciprocating compressor, according to claim 11, characterized in that the stator (400) is fixed to the assembly block (100) by means of a second fixing arrangement (420).

14. Reciprocating compressor, according to claim 11, characterized in that it further comprises a first hydrodynamic radial bearing (500a) formed in the space between the inner face of the first through hole (120a) and the rotating shaft first part (200a).

15. Reciprocating compressor, according to claim 11, characterized in that it further comprises a second hydrodynamic radial bearing (500b) formed in the space between the inner face of the second through hole (120b) and the rotating shaft second part (200b).

16. Reciprocating compressor, according to claim 11, characterized in that it further comprises an axial bearing (600) disposed between the eccentric pin (230) and the assembly block upper part (100a).

17. Reciprocating compressor, according to claim 11, characterized in that it further comprises an axial bearing (600) disposed between the bearing hub (700) and the rotor (300).

18. Reciprocating compressor, according to claim 11, characterized in that the stator (400) further comprises a radial bearing arranged around the rotating shaft (200), wherein the radial bearing is defined by an annular structure (610) which, projected from the stator (400), is arranged around a segment of the rotating shaft (200).

19. Reciprocating compressor, according to any one of the preceding claims, characterized in that the rotor (30, 300) is above the stator (40, 400), and the rotor (30, 300) comprises a support structure (A) in “Z” format for fixing to the rotating shaft (20, 200).

20. Reciprocating compressor, according to any of the preceding claims, characterized in that the rotor (30, 300) and stator (40, 400) are separated by a first axial clearance (F1), and the rotor (30, 300) and mounting block (10, 100) are separated by a second axial clearance (F2).

21. Reciprocating compressor, according to any one of the preceding claims, characterized in that the rotor (30, 300) and stator (40, 400) are separated by a first axial clearance (F1), and the shaft (20, 200) and mounting block (10, 100) are separated by a second axial clearance (F3).

22. Reciprocating compressor, according to any one of the preceding claims, characterized in that the first clearance (F1) and the second clearance (F2), (F3) are adjustable using a bushing (B) disposed between the rotor (30, 300) and the rotating shaft (20, 200).

23. Reciprocating compressor, according to any one of the preceding claims, characterized in that the first clearance (F1) is formed by the displacement of the rotor (30, 300) or the stator (40,400) and the second clearance (F2), (F3) is generated by displacing the bushing (B).

24. Reciprocating compressor, according to any one of the preceding claims, characterized in that it comprises an oil pump (Cl) with a frustum-conical shape provided in the inner axial channel (21) of the rotating shaft (20, 200); or provided in the rotor (30, 300).
